(19) United States
(12) Patent Application Publication
(10) Pub. No.: US 2013/0080412 A1
(43) Pub. Date: Mar. 28, 2013

(54) SHORT SEARCH RESULT ALONG WITH QUERY SUGGESTIONS

(71) Applicants: Barry A. Kritt, Raleigh, NC (US); Sarbajit K. Rakshit, Kolkata (IN)

(72) Inventors: Barry A. Kritt, Raleigh, NC (US); Sarbajit K. Rakshit, Kolkata (IN)

(73) Assignee: INTERNATIONAL BUSINESS MACHINES CORPORATION, Armonk, NY (US)

(21) Appl. No.: 13/240,490

(22) Filed: Sep. 22, 2011

(51) Int. Cl. G06F 17/30

(52) U.S. Cl. 707/706; 707/E17.108

(57) ABSTRACT

There are provided a system, a method and a computer program product for enhancing a capability of an Internet search engine. A user enters, by using an input device, a first query or an incomplete in a first search engine run by a computing system. While the user is entering the first query or the incomplete, the computing system suggests at least one complete query. While the user is entering the first query or the incomplete, the computing system searches at least one answer corresponding to the at least one suggested complete query. While the user is entering the first query or the incomplete, the computing system filters the at least one suggested complete query and the at least one searched answer. While the user is entering the first query or the incomplete, the computing system displays the at least one filtered complete query and at least one filtered answer.

### BACKGROUND

The present application generally relates to an Internet search engine. More particularly, the present application relates to providing query suggestions and answers corresponding to the query suggestions at the same time.

By using an Internet search engine (e.g., Google®, Yahoo!®, Bing® web sites, etc.), a user may want to find a single answer, e.g., a date of birth of any person, a capital of a country, a current time, a weather, etc. When a user wants to find a date of birth of a person, e.g., by typing “Birthday of” in an Internet search engine, etc., the Internet search engine may display a list of query suggestions. However, for example, if the user wants to find dates of birth of multiple people by using a current Internet search engine, then the user has to search multiple times to find those dates of birth of multiple people. In another example, if the user wants to find the capitals of multiple countries by using a current Internet search engine, then the user has to run the current Internet search engine multiple times.

### SUMMARY OF THE INVENTION

The present disclosure describes a system, method and computer program product for enhancing a capability of an Internet search engine, e.g., by providing a query suggestion(s) and an answer(s) corresponding to the query suggestion(s) at the same time.

In one embodiment, there is provided a system for enhancing a capability of an Internet search engine. The system includes an input device for receiving, from a user, a first query or an incomplete query at a first search engine run by a computing system including at least one memory device and at least one processor connected to the memory device. While the user is entering the first query or the incomplete query, the computing system is configured to suggest at least one complete query. While the user is entering the first query or the incomplete query, the computing system is configured to search at least one answer corresponding to the at least one suggested complete query. While the user is entering the first query or the incomplete query, the computing system filters the at least one suggested complete query and the at least one searched answer. While the user is entering the first query or the incomplete query, the computing system is configured to display the at least one filtered complete query and the at least one filtered searched answer.

In a further embodiment, the user chooses at least one filter criterion. The at least one suggested complete query and the at least one searched answer are filtered based on the at least one chosen filter criterion.

In a further embodiment, to filter the at least one suggested complete query and the at least one searched answer, the computing system is configured to perform a logical operation on the at least one suggested complete query with the chosen criterion. The logical operation includes one or more of: a logical AND operation, a logical OR operation, and an excluding operation.

In a further embodiment, the computing system is configured to store, in the memory device, the at least one chosen filter criterion in order to memorize the chosen filter criterion.

In a further embodiment, if the user points, by using a control device, a cursor over the displayed at least one searched answer, then the computing system is configured to display detailed information of the at least one displayed answer pointed by the control device.

In a further embodiment, to display the detailed information, the computing system is configured to run a second search engine to search for the detailed information according to the chosen criterion and a query corresponding to the displayed answer pointed by the control device.

In a further embodiment, the at least one searched answer is data obtained from Internet in real-time.

In a further embodiment, the at least one searched answer is data stored in the at least one memory device in the computing system.

In a further embodiment, the computing system is configured to display all suggested queries and all searched answers corresponding to the all the suggested queries.

### BRIEF DESCRIPTION OF THE DRAWINGS

The accompanying drawings are included to provide a further understanding of the present invention, and are incorporated in and constitute a part of this specification.

FIG. 1 is an exemplary diagram of an Internet search engine in one embodiment.

FIG. 2 is an exemplary diagram of an Internet search engine in one embodiment.

FIG. 3 is a flow chart that describes method steps for improving an Internet search engine in one embodiment.

FIGS. 4A-4D illustrate exemplary diagrams showing query suggestions and answers corresponding to the query suggestions at the same time in one embodiment.

FIG. 5 illustrates an exemplary diagram using a known mouse hovering technique in one embodiment.

FIG. 6 illustrates an exemplary hardware configuration for implementing the flow chart depicted in FIG. 3 in one embodiment.

FIG. 7 is an exemplary diagram of an Internet search engine in one embodiment.

FIG. 8 is a system diagram illustrating an environment running search engines in one embodiment.

FIG. 9 is a flow chart that describes method steps that employs the second search engine to implement the mouse hovering technique in one embodiment.

FIG. 10 is a flow chart that describes operations of the first and second search engines in one embodiment.

### DETAILED DESCRIPTION

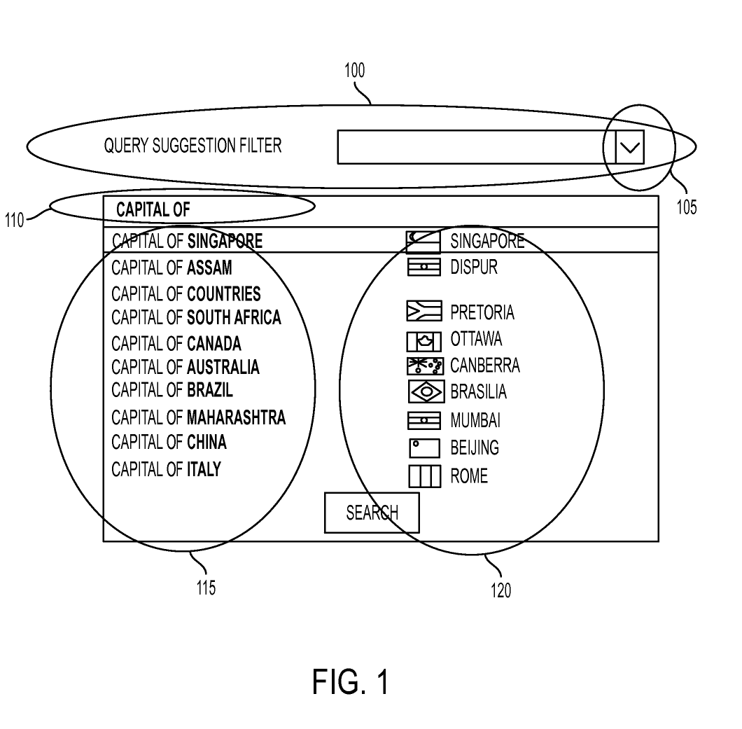

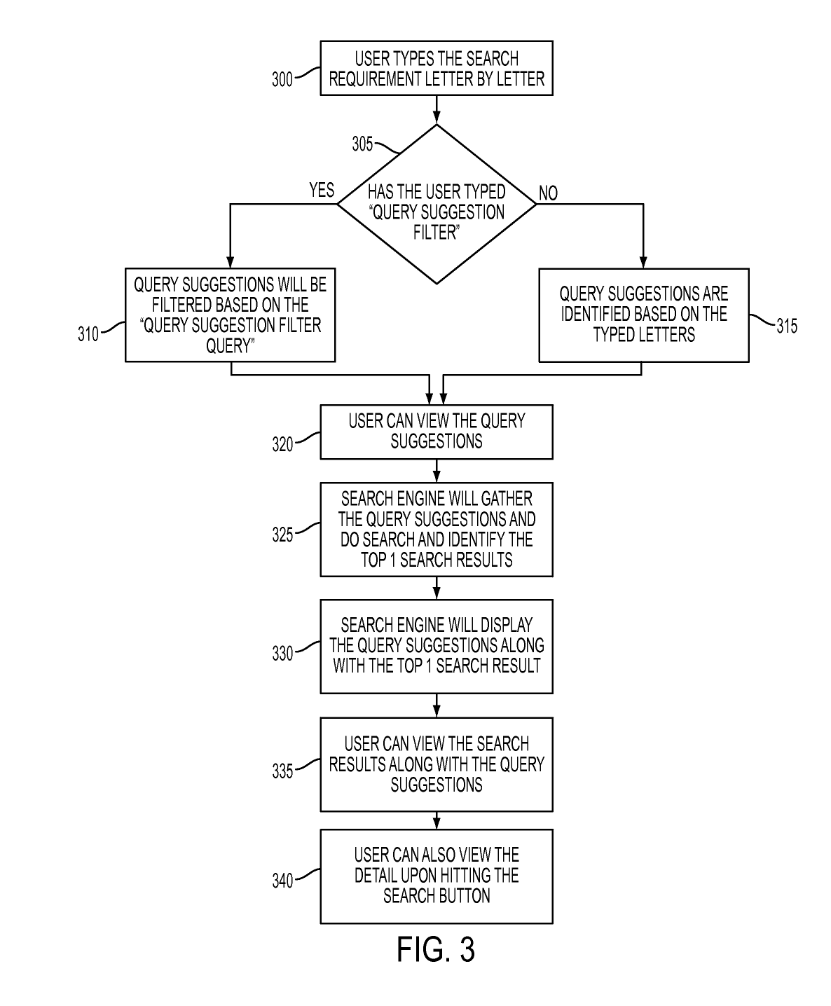

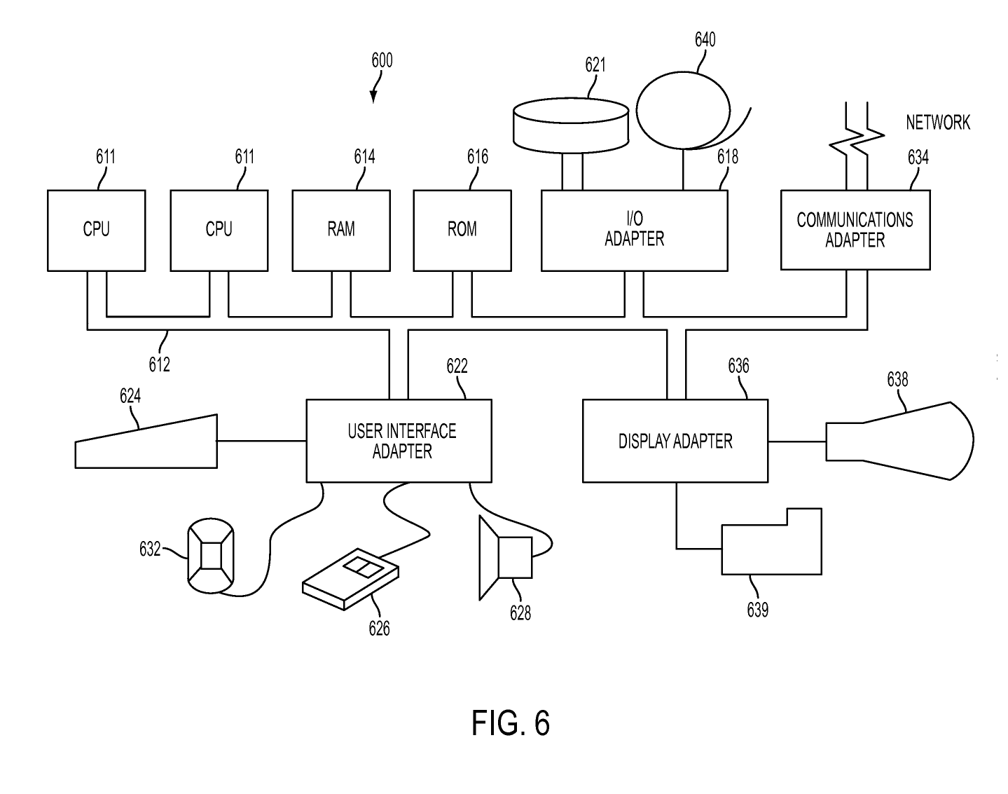

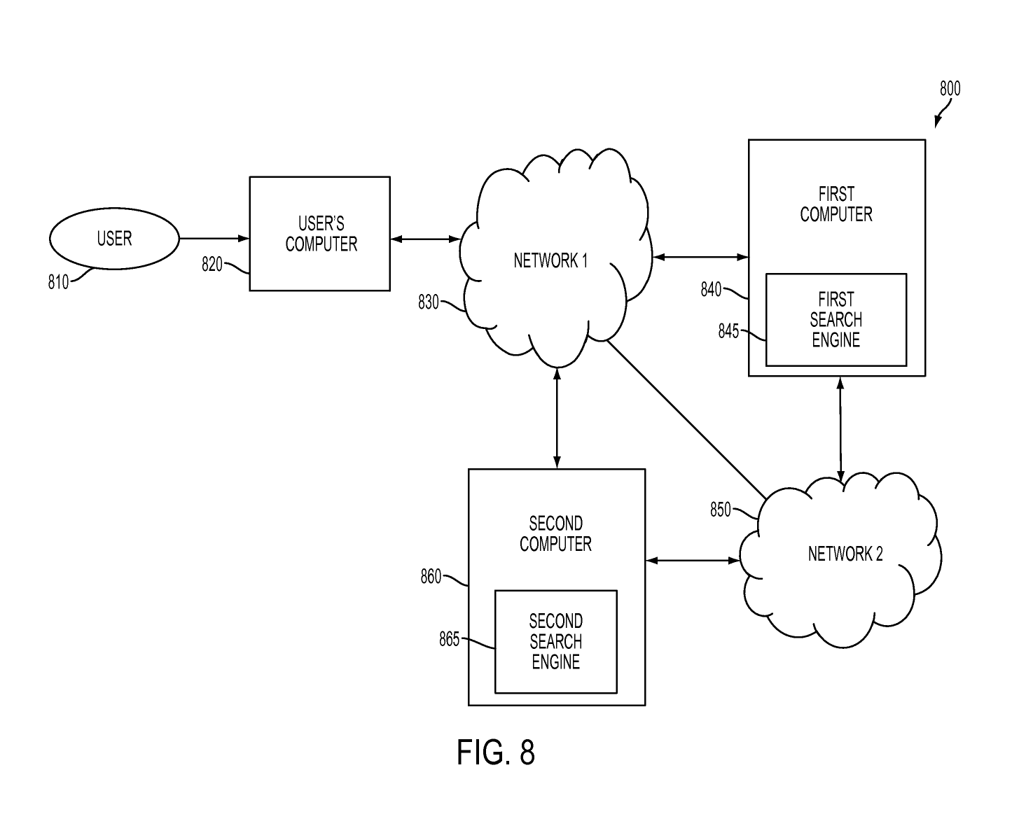

FIG. 3 is a flow chart that describes method steps for enhancing a capability of an Internet search engine (e.g., Google®, Yahoo!®, Bing®, etc.) in one embodiment. FIG. 8 is a system diagram that illustrates an environment for implementing the method steps in FIG. 3 in one embodiment. At step 300 in FIG. 3, a user (e.g., a user 810 shown in FIG. 8) enters a first query or an incomplete query, e.g., by using a user's computer (e.g., user's computer 820 shown in FIG. 8) via a web browser (e.g., Mozilla® Firefox®, Microsoft® Internet Explorer®, etc.) or a similar tool, in a first Internet search engine (e.g., a first search engine 845 hosted by a first computing system 840 as shown in FIG. 8). As shown in FIG. 8, the user's computer 820 and the first computing system 840 are connected each other via a network 1 (830) (e.g., Internet, wireless network, wired network, Intranet, etc.). For example, as shown in FIGS. 1 and 8, the user may type, e.g., by using an input device (a keyboard, etc.), “capital of” 110 for a receipt in the first Internet search engine 845 hosted by the first computing system 840 (e.g., a computing system 600 shown in FIG. 6). At step 305 in FIG. 3, the first computing system is configured to evaluate whether the user wants to use a query suggestion filter (e.g., a query suggestion filter 100 shown in FIG. 1) described in detail below. If the user wants to use the query suggestion filter, at step 310 in FIG. 3, the first computing system enables the query suggestion filter, e.g., by displaying the query suggestion filter 100 to the user via a display device (e.g., monitor device, etc.). Otherwise, if the user does not want to use the query suggestion filter, at step 315 in FIG. 3, the first computing system disables the query suggestion filter, e.g., by not showing the query suggestion filter 100 to the user. In one embodiment, the first computing system provides a graphical interface (not shown) via which the user can select whether to use the query suggestion filter or not.

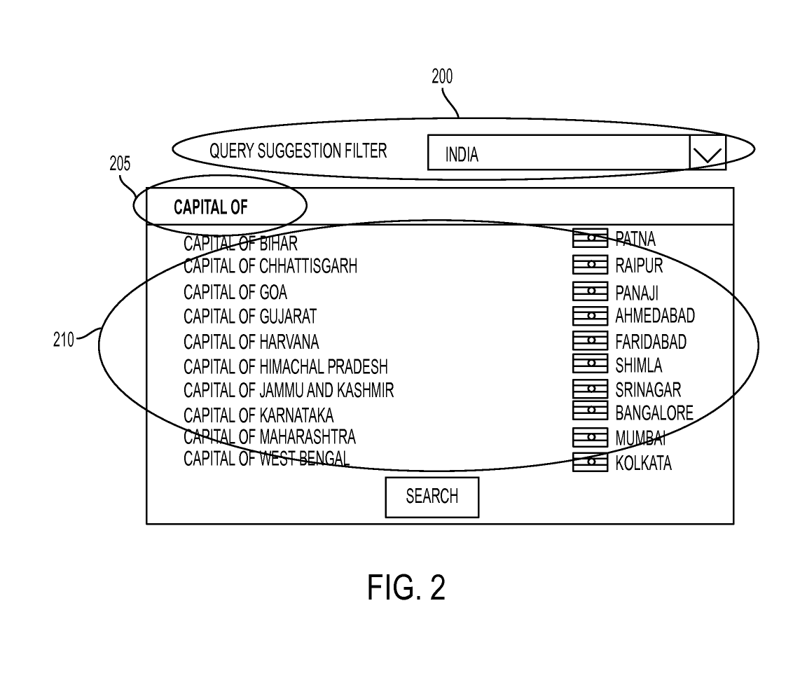

At step 320 in FIG. 3, as shown in FIG. 1, the first computing system is configured to suggest (i.e., search and display) at least one complete query (e.g., a plurality of complete queries 115 suggested by the computing system), while the user is entering the first query or the incomplete query. Andrew et al., “Query Suggestion Generation,” US Patent Application Publication No. 2009/0187515 A1, wholly incorporated by reference as set forth herein, hereinafter “Andrew,” describes one manner in which a computing system suggests queries in detail. At steps 325, the first computing system is configured to search at least one answer (e.g., answers 120 shown in FIG. 1) corresponding to the suggested complete query or queries, e.g., by running a first Internet search engine (e.g., Google®, etc.; a first search engine 845 hosted by a first computing system 840 as shown FIG. 8) with the suggested complete query, while the user is entering the first query or the incomplete query. As shown in FIG. 8, the first computing system hosting the first search engine 845 is connected to a second computing system 860 hosting a second search engine 865 (e.g., Wikipedia®, etc.) via a network 2 (850) (e.g., Internet, Intranet, wireless network, wired network, etc.). In one embodiment, the first search engine 845 and the second search engine 865 are two different search engines. In another embodiment, the first search engine and the second search engine are the same search engine. In one embodiment, a user selects the second search engine 865 with a URL, e.g., http://en.wikipedia.org, e.g., from a drop-down menu (not shown) in a graphical interface (not shown) of the first search engine. The network 1 (830) and the network 2 (850) may be the same network or be connected each other. If the user chooses to use the query suggestion filter (e.g., query suggestion filter 100 shown in FIG. 1), e.g., by using a drop-down menu 105 shown in FIG. 1, the query suggestion filter filters the suggested complete query and the searched answer while the user is entering the first query or the incomplete query. At steps 330-335, the computing system is configured to display the filtered complete query and the filtered answer (e.g., filtered complete query and filtered answer 210 shown in FIG. 2) while the user is entering the first query or the incomplete query. At step 340, the user can view detailed information of one or more of the filtered complete query and/or the corresponding answer, e.g., by selecting, e.g., by mouse device clicking the one or more of the suggested complete query and/or the corresponding answer.

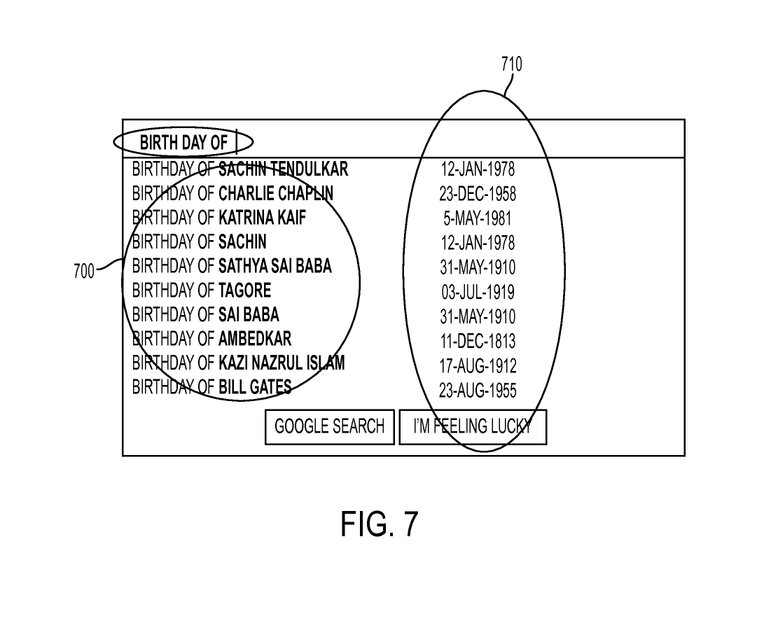

If the user does not use the query suggestion filter, at step 325, the first computing system is configured to search, e.g., by running the first Internet search engine, all the answers to the all the suggested complete queries. At step 330-335, the first computing system displays all the suggested complete queries along with the all the searched answers, e.g., via a display device (e.g., a monitor device, etc.) of the user's computer. For example, as shown in FIG. 7, the first computing system is configured to display all the suggested queries 700 along with all the answers 710 corresponding to all the suggested queries 700. Note that as shown in FIGS. 1-2 and 7, the displayed answers are actual answers to the suggested queries. For examples, as shown in FIG. 1, if the suggested queries are capitals of countries or states 115, the displayed answers 120 are names of capitals of these countries or states. As a further example, as shown in FIG. 7, if the suggested queries are birthdays of people 700, the displayed answers 710 are the dates of birth of these people. Note that FIG. 7 is an exemplary figure that illustrates a functionality of the present invention in one embodiment. At step 340 in FIG. 3, the user can view detailed information of one of all the suggested complete queries or detailed information of one of all the corresponding answers, e.g., by selecting, e.g., by mouse device clicking, one of the suggested complete queries or by clicking one of the corresponding answers by using a control device (e.g., a mouse device, etc.).

The query suggestion filter filters the suggested complete query(s) and/or the searched answer(s). In one embodiment, the user chooses at least one filter criterion (e.g., a criterion “India” 200 shown in FIG. 2), e.g., by using a drop-down menu bar 105 shown in FIG. 1 or the user enters the filter criterion, e.g., by using a keyboard, etc. The first computing system is configured to filter the suggested complete query(s) and the searched answer(s) based on the chosen or entered filter criterion. As shown in FIGS. 1-2, the first computing system is configured to filter suggested complete queries 115 and their corresponding answers 120 based on the chosen or entered filter criterion 200. Then, the first computing system is configured to obtain filtered complete queries and their corresponding answers 210, e.g., by running a logical operation on the suggested complete queries 115 and their corresponding answers with the chosen or entered filter criterion 200. The logical operation includes, but is not limited to: a logical AND operation, a logical OR operation, and an excluding operation (i.e., excluding certain suggested queries and their corresponding answers based on the chosen criterion). Unless the user specifies, e.g., through the drop-down menu 105 shown in FIG. 1, the first computing system performs the logical AND operation as a default choice to filter complete queries and their corresponding answers. For example, as shown in FIG. 1, if the suggested queries are capitals of countries or states 115, the computing system is configured to display all the corresponding answers 120 (e.g., a capital of South Africa is Pretoria, etc.). As shown in FIGS. 1-2, if the user chooses a criterion 200 (e.g., “India”) to filter the suggested queries and the corresponding answers, e.g., by using a drop-down menu bar 105 of the query suggestion filter 100, the computing system is configured to perform a logical AND operation between the suggested queries 115 (e.g., capitals of countries or states) and the chosen criterion (e.g., “India”). Then, as shown in FIG. 2, the computing system is configured to displays filtered queries and all the corresponding answers (e.g., capitals of Indian states or provinces and names of these capitals 210).

In one embodiment, the first computing system is configured to store the chosen or entered filter criterion in a memory device (e.g., a random access memory 615 shown in FIG. 6) in the first computing system in order to memorize the chosen or entered filter criterion.

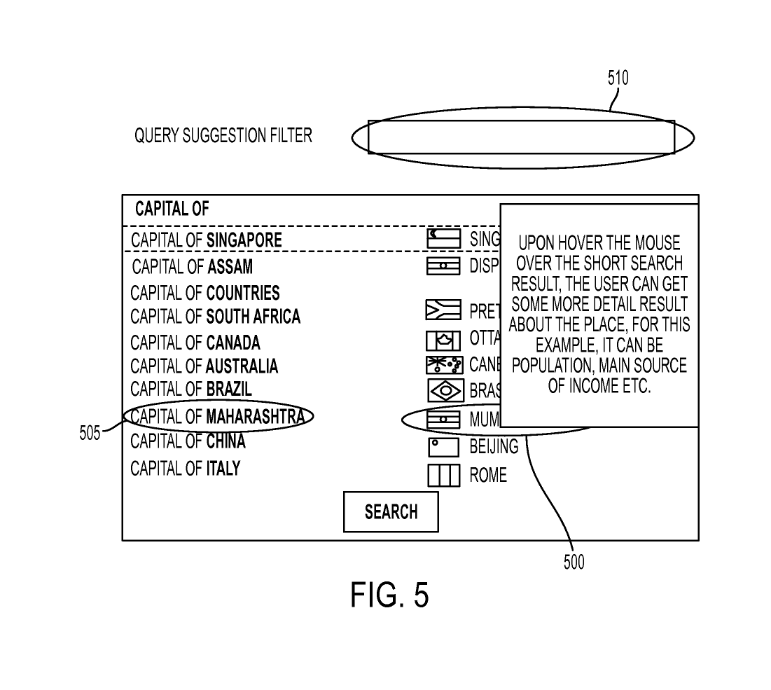

In one embodiment, as shown in FIG. 5, the user points, by using a control device (e.g., a mouse device, etc.) (not shown), a cursor (not shown) over a displayed answer (e.g., an answer 500). Then, the first computing system searches for detailed information about the displayed answer pointed by the control device, e.g., by running the second Internet search engine with the chosen or entered filter criterion and a query corresponding to the displayed answer pointed by the control device. Upon finding, from the second Internet search engine, the detailed information of the displayed answer pointed by the control device, the first computing system is configured to display the detailed information, e.g., via a display device (e.g., monitor device, etc.) of the user's computer. For example, as shown in FIG. 5, if the user places a cursor over “Mumbai” 500, the first computing system runs the second Internet search engine with “capital of maharashtra” 505, “Mumbai” 500 and/or a chosen or entered filter criterion 510. Then, the second Internet search engine may produce detailed information (e.g., population, main source of income, etc.) of “Mumbai.” Then, the computing system displays the produced detailed information over the displayed answer to the user, e.g., via a display device (e.g., a monitor device, etc.) of the user's computer by using a known mouse hovering technique.

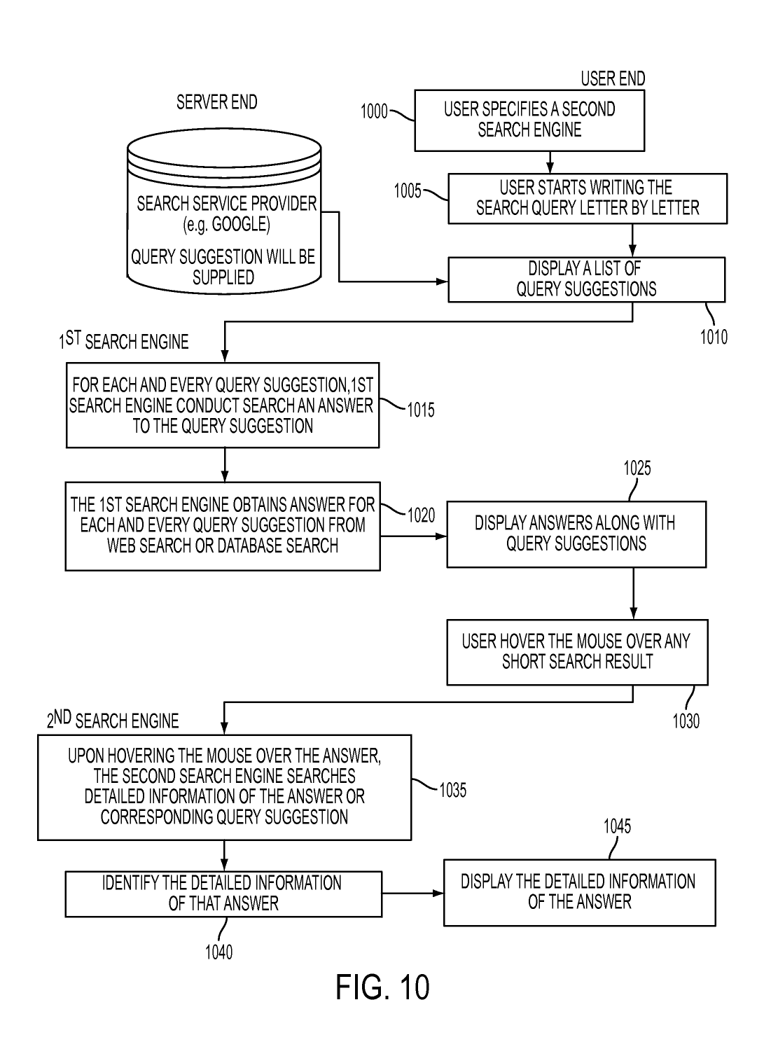

FIG. 10 is a flow chart that describes operations of the first and second search engines in one embodiment. At step 1000 in FIG. 10, the user determines which Internet search engine the user is going to use as the second search engine, e.g., by selecting a URL of the second search engine in a drop-down menu (not shown) in a graphical interface (not shown) of the first search engine. At step 1005, a user writes an incomplete query (e.g., an incomplete query “capital of” 110 shown in FIG. 1) letter by letter in the first search engine. At step 1010 in FIG. 10, the first search engine supplies corresponding query suggestions (e.g., query suggestions 115 shown in FIG. 1), e.g., by using known query suggestion techniques such as described in “Andrew” reference. At steps 1015-1020, the first search engine searches and obtains potential answers to the query suggestions. In one embodiment, the first search engine obtains the answers (e.g., Capital, Date of births, etc.), e.g., from a stored database. In another embodiment, the first search engine obtains the answers (e.g., Weather, Currency conversion factor, etc.) in real-time, e.g., from web pages (e.g., http://www.weather.com). For example, for every query suggestion, the first search engine searches a plurality of web pages, and obtains answers to every query suggestion, e.g., based on a ranking of those web pages determined by the first search engine. In one embodiment, a ranking of a web page is determined by a reputation (i.e., number of visits) of that web page. If two different web pages describe two different answers, the first search engine chooses an answer in a web page with a higher ranking.

At step 1025 in FIG. 10, the first search engine displays all the obtained answers (e.g., answers 120 in FIG. 1) to all the query suggestions, e.g., through a display device (not shown). At step 1030 in FIG. 10, the user hovers the control device (e.g., mouse device) over any answer. At step 1035 in FIG. 10, upon the user hovering the control device over an answer, the second search engine searches detailed information of that answer and/or corresponding query suggestion. At step 1040 in FIG. 10, the second search engine obtains the detailed information of the answer, e.g., from Wikipedia®, etc. The second search engine displays the detailed information to the user, e.g., through the display device, etc.

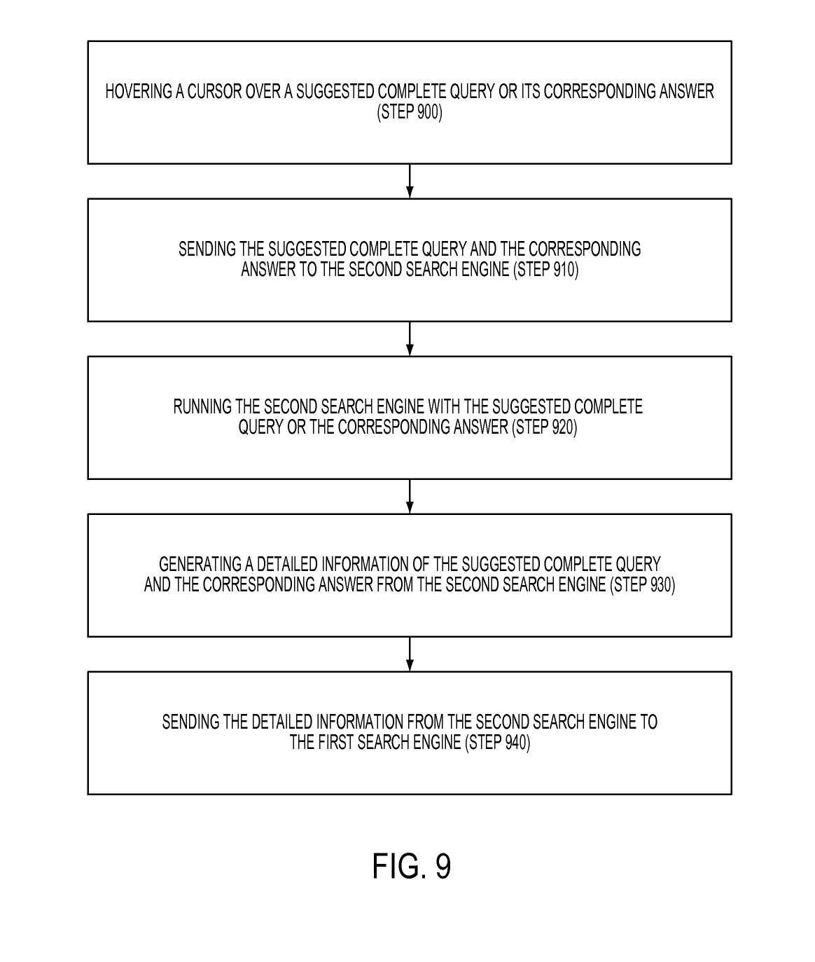

FIG. 9 is a flow chart that describes method steps that employs the second search engine to implement the mouse hovering technique in one embodiment. At step 900, a user hovers, by using a control device (e.g., a mouse device, etc.), a cursor over a suggested complete query or its corresponding answer. Then, at step 910, the first search engine sends that suggested complete query and that corresponding answer to the second search engine, e.g., via a network 2 (850) shown in FIG. 8. Upon receiving those suggested complete query and corresponding answer, at step 920, the second computing system hosting the second search engine runs the second search engine with the received suggested complete query and/or the received corresponding answer. At step 930, the second search engine generates detailed information of the received suggested complete query and the received corresponding answer, e.g., by searching or crawling web documents associated with the received suggested complete query and the received corresponding answer. At step 940, the second computing system provides the generated detailed information to the first search engine. Then, the first search engine displays, via a display device in the user's computer, the generated detailed information to the user.

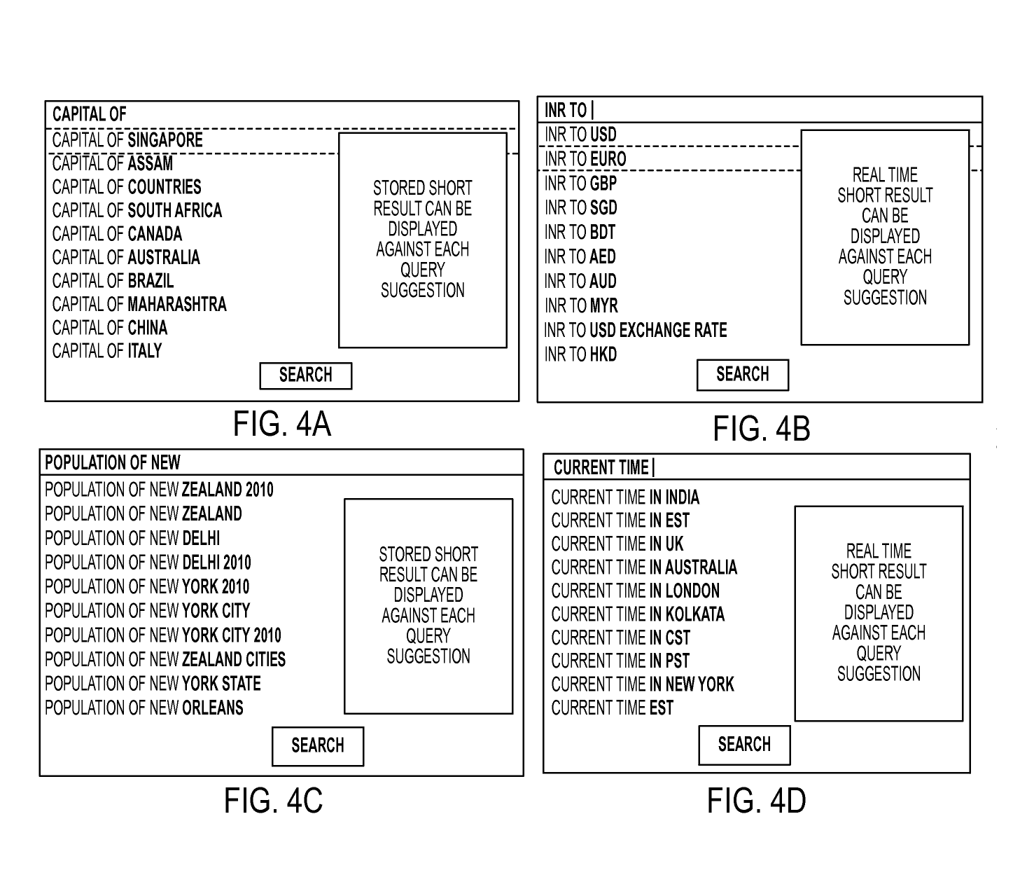

In one embodiment, as shown in FIGS. 4B and 4D, the first computing system is configured to obtain the searched answer from Internet in real-time. The real-time answer to the suggested complete query or queries includes, but is not limited to: current conversion information, current time information, current weather information, current traffic information, etc. In another embodiment, as shown in FIGS. 4A and 4C, the first computing system is configured to obtain the searched answer (e.g., answers 120 in FIG. 1, etc.) from a memory device in the first computing system or a local knowledge base associated with the first computing system. The memory device in the first computing system may store the searched answer, e.g., based on prior running of the first Internet search engine with the corresponding query. The stored answer may include, but is not limited to: a capital of a country or a state, a population of a country or a state or a city or a town, a date of birth of a person, etc., for examples herein provided.

FIG. 6 illustrates an exemplary hardware configuration of the computing system 600 that runs the method steps described in FIG. 3. The hardware configuration preferably has at least one processor or central processing unit (CPU) 611. The CPUs 611 are interconnected via a system bus 612 to a random access memory (RAM) 614, read-only memory (ROM) 616, input/output (I/O) adapter 618 (for connecting peripheral devices such as disk units 621 and tape drives 640 to the bus 612), user interface adapter 622 (for connecting a keyboard 624, mouse 626, speaker 628, microphone 632, and/or other user interface device to the bus 612), a communication adapter 634 for connecting the system 600 to a data processing network, the Internet, an Intranet, a local area network (LAN), etc., and a display adapter 636 for connecting the bus 612 to a display device 638 and/or printer 639 (e.g., a digital printer of the like).

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon. In a further embodiment, the computing system analyzes properties of the enterprise and market social networks to build features for predictive models of a propensity for a customer to buy a product, or to close a deal in a particular period of time.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with a system, apparatus, or device running an instruction.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with a system, apparatus, or device running an instruction.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may run entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which run via the processor of the computer or other programmable data processing apparatus, create means for implementing the functions/acts specified in the flowchart and/or block diagram block or blocks. These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which run on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more operable instructions for implementing the specified logical function(s). It should also be noted that, in some alternative implementations, the functions noted in the block may occur out of the order noted in the figures. For example, two blocks shown in succession may, in fact, be run substantially concurrently, or the blocks may sometimes be run in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for enhancing a capability of an Internet search engine, the method comprising:
receiving, from a user, a first query or an incomplete query at a first search engine;
suggesting, by a computing system including at least one memory device and at least one processor connected to the memory device, at least one complete query while the user is entering the first query or the incomplete query;
searching, by the computing system, at least one answer corresponding to the at least one suggested complete query while the user is entering the first query or the incomplete query;
filtering, by the computing system, the at least one suggested complete query and the at least one searched answer while the user is entering the first query or the incomplete query; and
displaying, by the computing system, the at least one filtered complete query and the at least one filtered searched answer while the user is entering the first query or the incomplete query.

2. The method according to claim 1, wherein the step of filtering further comprising:
choosing, by a user, at least one filter criterion,
wherein the at least one suggested complete query and the at least one searched answer are filtered based on the at least one chosen filter criterion.

3. The method according to claim 2, wherein the step of filtering further comprises:
performing a logical operation on the at least one suggested complete query with the chosen filter criterion, wherein the logical operation includes one or more of: a logical AND operation, a logical OR operation, and an excluding operation.

4. The method according to claim 3, further comprising:
storing, in the memory device, the at least one chosen filter criterion in order to memorize the at least one chosen filter criterion.

5. The method according to claim 1, further comprising:
pointing, by the user by using a control device, a cursor over the displayed at least one searched answer; and
displaying, by the computing system, detailed information of the displayed at least one searched answer pointed by the control device.

6. The method according to claim 5, wherein the step of displaying the detailed information includes:
running a second search engine to search for the detailed information according to the chosen filter criterion and a query corresponding to the displayed at least one searched answer pointed by the control device.

7. The method according to claim 1, wherein the at least one searched answer is data obtained from Internet in real-time.

8. The method according to claim 1, wherein the at least one searched answer is data stored in the at least one memory device in the computing system.

9. The method according to claim 1, further comprising:
displaying all suggested queries and all searched answers corresponding to the all the suggested queries.

10. A system for enhancing a capability of an Internet, the method comprising:
an input device for receiving, from a user, a first query or an incomplete query for a first search engine run by a computing system including at least one memory device and at least one processor connected to the memory device,
wherein the computing system is configured to:
suggest at least one complete query while the user is entering the first query or the incomplete query; and
search at least one answer corresponding to the at least one suggested complete query while the user is entering the first query or the incomplete query;
filter the at least one suggested complete query and the at least one searched answer while the user is entering the first query or the incomplete query; and
display the at least one filtered complete query and the at least one filtered searched answer while the user is entering the first query or the incomplete query.

11. The system according to claim 11, wherein the user chooses at least one filter criterion, and the at least one suggested complete query and the at least one searched answer are filtered based on at least one chosen filter criterion.

12. The system according to claim 11, wherein to filter the at least one suggested complete query, the computing system is further configured to:
perform a logical operation on the at least one suggested complete query with the chosen filter criterion, wherein the logical operation includes one or more of: a logical AND operation, a logical OR operation, and an excluding operation.

13. The system according to claim 12, wherein the computing system is further configured to:
point, by the user by using a control device, a cursor over the displayed at least one searched answer; and
display detailed information of the displayed at least one searched answer pointed by the control device.

14. The system according to claim 13, wherein to display the detailed information, the computing system is further configured to:
run a second search engine to search for the detailed information according to the chosen filter criterion and a query corresponding to the displayed at least one searched answer pointed by the control device.

15. A computer program product for enhancing a capability of an Internet, the computer program product comprising a storage device readable by a processing circuit and storing instructions run by the processing circuit for performing a method, the method comprising:
receiving, from a user, a first query or an incomplete query at a first search engine;
suggesting at least one complete query while the user is entering the first query or the incomplete query;
searching at least one answer corresponding to the at least one suggested complete query while the user is entering the first query or the incomplete query;
filtering the at least one suggested complete query and the at least one searched answer while the user is entering the first query or the incomplete query; and
displaying the at least one filtered complete query and the at least one filtered searched answer while the user is entering the first query or the incomplete query.

16. The computer program product according to claim 15, wherein the step of filtering further comprising:
choosing, by a user, at least one filter criterion,
wherein the at least one suggested complete query and the at least one searched answer are filtered based on the at least one chosen filter criterion.

17. The computer program product according to claim 16, wherein the step of filtering further comprises:
performing a logical operation on the at least one suggested complete query with the chosen filter criterion, wherein the logical operation includes one or more of: a logical AND operation, a logical OR operation, and an excluding operation.

18. The computer program product according to claim 15, wherein the method further comprises:
pointing, by the user by using a control device, a cursor over the displayed at least one searched answer; and
displaying detailed information of the displayed at least one searched answer pointed by the control device.

19. The computer program product according to claim 18, wherein the step of the detailed information includes:
running a second search engine to search for the detailed information according to the chosen filter criterion and a query corresponding to the displayed at least one searched pointed by the control device.

20. The computer program product according to claim 15, wherein the method further comprises:
displaying all suggested queries and all searched answers corresponding to the all the suggested queries.
